(19) United States
(12) Patent Application Publication
(10) Pub. No.: US 2025/0192263 A1
(43) Pub. Date: Jun. 12, 2025

(54) THERMAL BARRIER ASSEMBLIES WITH HEAT SPREADING FEATURES FOR USE WITHIN TRACTION BATTERY PACKS

(71) Applicant: FORD GLOBAL TECHNOLOGIES, LLC, Dearborn, MI (US)

(72) Inventors: George Albert Garfinkel, Westland, MI (US); Deanna Marie Winton Hoffman, Ann Arbor, MI (US); Daniel Benjamin Kok, Ann Arbor, MI (US); Suman Mishra, Canton, MI (US); Kanchana Perumalla, Troy, MI (US); Brad Alan VanDerWege, Plymouth, MI (US)

(21) Appl. No.: 18/745,052

(22) Filed: Jun. 17, 2024

Related U.S. Application Data
(60) Provisional application No. 63/607,888, filed on Dec. 8, 2023.

(51) Int. Cl. H01M 10/625; H01M 10/6551; H01M 10/6554; H01M 10/658; H01M 50/204; H01M 50/249

(52) U.S. Cl. CPC H01M 10/625; H01M 10/6551; H01M 10/6554; H01M 10/658; H01M 50/204; H01M 50/249; H01M 2220/20

(57) ABSTRACT

Thermal barrier assemblies are provided for inhibiting the transfer of thermal energy inside a traction battery pack. An exemplary thermal barrier assembly may include a heat spreader fin arranged within a cell stack and configured to provide a path for directing thermal energy into an enclosure structure rather than through the thermal barrier assembly to a cold side of the cell stack. The heat spreader fin may extend to a location that is either between an insulating layer of the thermal barrier assembly and the enclosure structure or between a grouping of battery cells of the cell stack and the enclosure structure.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to thermal barrier assemblies arranged for mitigating the transfer of thermal energy within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a thermal barrier assembly arranged to partition a battery cell stack into a first compartment and a second compartment. A first heat spreader fin of the thermal barrier assembly is configured to establish a path for directing thermal energy from a battery cell of the battery cell stack into an enclosure structure of the traction battery pack. The first heat spreader fin extends between a first insulation layer of the thermal barrier assembly and the enclosure structure or extends between the battery cell and the enclosure structure.

In a further non-limiting embodiment of the foregoing traction battery pack, the enclosure structure is a heat exchanger plate of the traction battery pack.

In a further non-limiting embodiment of either of the foregoing traction battery packs, the first heat spreader fin includes an L-shaped cross-section.

In a further non-limiting embodiment of any of the foregoing traction battery packs, the first heat spreader fin includes a metallic structure.

In a further non-limiting embodiment of any of the foregoing traction battery packs, the first heat spreader fin is sandwiched between the first insulation layer and a first foam layer of the thermal barrier assembly.

In a further non-limiting embodiment of any of the foregoing traction battery packs, the first heat spreader fin is sandwiched between the first insulation layer and a thermal barrier structure of the thermal barrier assembly.

In a further non-limiting embodiment of any of the foregoing traction battery packs, the thermal barrier structure is a pultrusion.

In a further non-limiting embodiment of any of the foregoing traction battery packs, the thermal barrier structure includes an upper interfacing structure having an upper plateau configured to interface with a second enclosure structure of the traction battery pack.

In a further non-limiting embodiment of any of the foregoing traction battery packs, the second enclosure structure is part of an enclosure cover of an enclosure assembly of the traction battery pack.

In a further non-limiting embodiment of any of the foregoing traction battery packs, a thermal interface material is disposed between the first heat spreader fin and the enclosure structure.

In a further non-limiting embodiment of any of the foregoing traction battery packs, a thermal interface material is disposed between the battery cell and the first heat spreader fin and further between the first heat spreader fin and the enclosure structure.

In a further non-limiting embodiment of any of the foregoing traction battery packs, the first heat spreader fin includes a body and a leg that extends transversely from the body.

In a further non-limiting embodiment of any of the foregoing traction battery packs, the leg extends to a position that is between the first insulation layer and the enclosure structure or between the battery cell and the enclosure structure.

In a further non-limiting embodiment of any of the foregoing traction battery packs, the leg extends from a first location of the body. A tab extends from a second location of the body.

In a further non-limiting embodiment of any of the foregoing traction battery packs, the leg extends beneath a bottom surface of the battery cell, and the tab extends to a position adjacent to an end surface of the battery cell.

A traction battery pack according to another exemplary aspect of the present disclosure includes, among other things, an upper enclosure structure, a lower enclosure structure, and a cell stack arranged between the upper enclosure structure and the lower enclosure structure. The cell stack includes a first grouping of battery cells, a second grouping of battery cells, and a thermal barrier assembly that separates the first grouping of battery cells from the second grouping of battery cells. The thermal barrier assembly includes a thermal barrier structure sandwiched between a first insulation layer and a second insulation layer, a first heat spreader fin that flanks the first insulation layer, and a second heat spreader fin that flanks the second insulation layer.

In a further non-limiting embodiment of the foregoing traction battery pack, the first heat spreader fin extends between the first insulation layer and the lower enclosure structure.

In a further non-limiting embodiment of either of the foregoing traction battery packs, the first heat spreader fin extends between the first grouping of battery cells and the lower enclosure structure.

In a further non-limiting embodiment of any of the foregoing traction battery packs, a second heat spreader fin of a second thermal barrier assembly extends between the first grouping of battery cells and the lower enclosure structure.

In a further non-limiting embodiment of any of the foregoing traction battery packs, the first heat spreader fin is flanked by a first foam layer, and the second heat spreader fin is flanked by a second foam layer.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view of select portions of a cell stack of a traction battery pack.

FIG. 4 illustrates an exemplary thermal barrier assembly of a cell stack of a traction battery pack.

FIG. 5 illustrates another exemplary thermal barrier assembly.

FIGS. 6 and 7 illustrate yet another exemplary thermal barrier assembly.

### DETAILED DESCRIPTION

This disclosure details thermal barrier assemblies configured for inhibiting the transfer of thermal energy inside a traction battery pack. An exemplary thermal barrier assembly may include a heat spreader fin arranged within a cell stack and configured to provide a path for directing thermal energy into an enclosure structure rather than through the thermal barrier assembly to a cold side of the cell stack. The heat spreader fin may extend to a location that is either between an insulating layer of the thermal barrier assembly and the enclosure structure or between a grouping of battery cells of the cell stack and the enclosure structure. These and other features are discussed in greater detail in the following paragraphs of this detailed description.

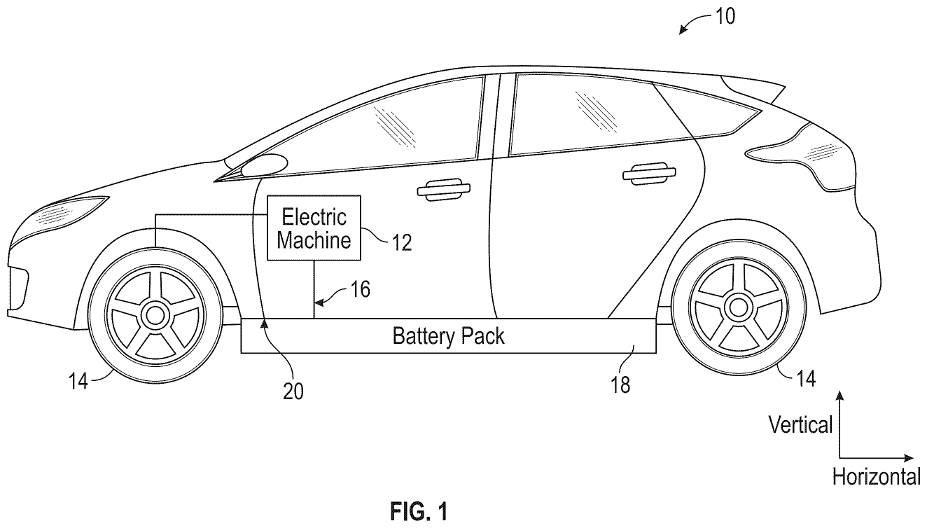

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

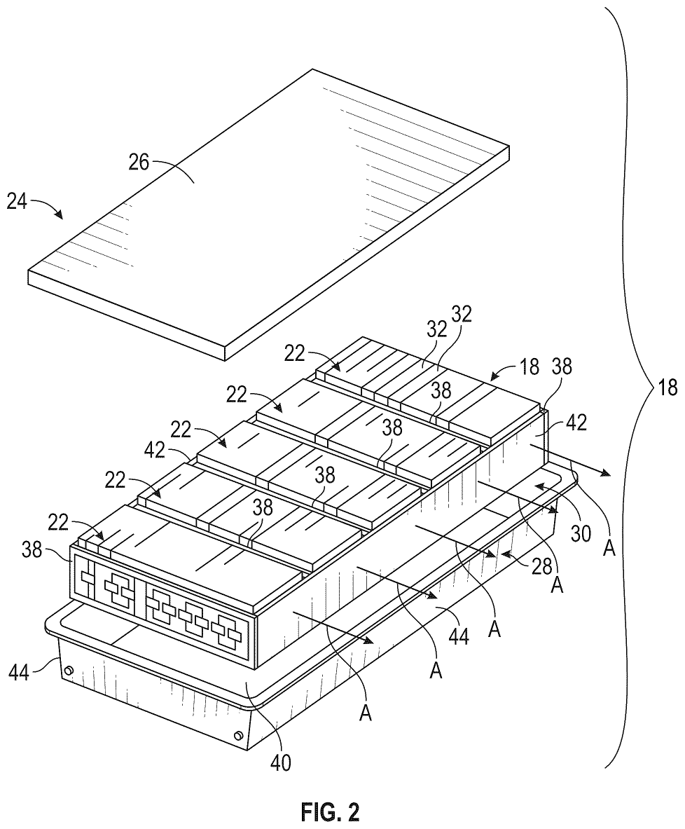

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural members that span across a majority of the length of the longitudinally extending side wall 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

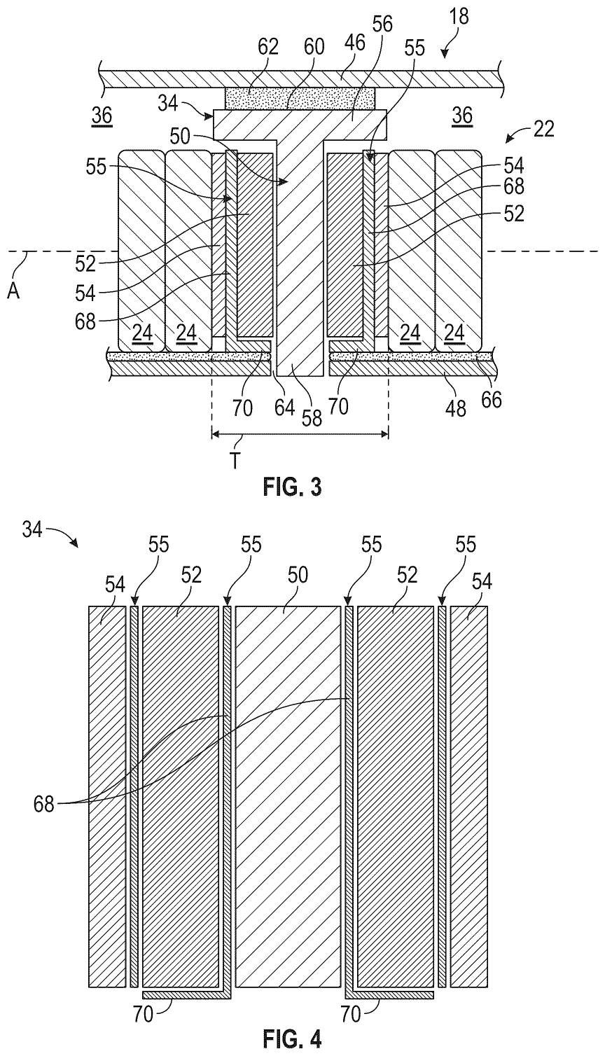

Referring now to FIG. 3, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more groupings or compartments 36 of battery cells 32. Each compartment 36 may hold one or more of the battery cells 32 of the cell stack 22.

Should, for example, a battery thermal event occur in one of the cell stacks 22, the thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18. As further explained below, the thermal barrier assemblies 34 may further be configured to structurally join battery enclosure structures to increase the structural integrity of the traction battery pack 18.

Each thermal barrier assembly 34 may be configured to establish a sealed interface at both an upper enclosure structure 46 and a lower enclosure structure 48 of the traction battery pack 18. The upper enclosure structure 46 may be part of the enclosure cover 26 of the enclosure assembly 24 or could be an intermediate structure (e.g., an actively cooled heat exchanger plate) that is positioned between the thermal barrier assembly 34 and the enclosure cover 26. The lower enclosure structure 48 may be part of the actively cooled heat exchanger plate 40 that is positioned between the structural thermal barrier assembly 34 and the enclosure tray 28, or could alternatively be part of the enclosure tray 28.

Each thermal barrier assembly 34 of the cell stack 22 may include a thermal barrier structure 50 that is flanked by pairs of insulation layers 52, heat spreader fins 55, and foam layers 54 as part of a multi-layer sandwich structure of the thermal barrier assembly 34. In the illustrated embodiment, the thermal barrier structure 50 may be sandwiched between the insulation layers 52, and the heat spreader fins 55 may be sandwiched between one of the insulation layers 52 and one of the foam layers 54. The foam layers 54 may be positioned in contact with major side surfaces of battery cells 32 located in adjacent compartments 36 of the cell stack 22.

The thermal barrier structure 50 may include a thermoplastic structure or a polymer composite structure (e.g., glass fiber reinforced polypropylene with an intumescent additive), for example, the insulation layers 52 may include aerogel layers or mica sheets, for example, the foam layers 54 may include polyurethane foam or silicone foam, for example, and the heat spreader fins 55 may be aluminum or stainless steel fins, for example. However, other materials or combinations of materials could be utilized to construct the subcomponents of the thermal barrier assembly 34 within the scope of this disclosure.

As will be appreciated by persons of ordinary skill in the art having the benefit of this disclosure, the exemplary thermal barrier assembly 34 of FIG. 3 is not shown drawn to scale. A thickness T (e.g., in a direction of the cell stack axis A) of the thermal barrier assembly 34 has been exaggerated to better illustrate its substituent components and their arrangement relative to one another. In an embodiment, the thickness T may be between about 10 mm and about 20 mm, for example. However, other thicknesses are contemplated within the scope of this disclosure. In this disclosure, the term “about” means that the expressed quantities or ranges need not be exact but may be approximated and/or larger or smaller, reflecting acceptable tolerances, conversion factors, measurement error, etc.

The thermal barrier structure 50 of the thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The thermal barrier structure 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the thermal barrier structure 50. In other implementations, the thermal barrier structure 50 could be an injection molded part or an extruded part.

The thermal barrier structure 50 of the thermal barrier assembly 34 may include an upper interfacing structure 56 that is configured to interface with the upper enclosure structure 46, and a lower interfacing structure 58 that is configured to interface with lower enclosure structure 48. Together, the upper interfacing structure 56 and the lower interfacing structure 58 may establish a T-shaped cross-section of the thermal barrier structure 50. However, other shapes are contemplated within the scope of this disclosure.

The upper interfacing structure 56 may provide an upper plateau 60 for securing the thermal barrier assembly 34 to the upper enclosure structure 46 via an adhesive 62. The adhesive 62 may be an epoxy based adhesive or a urethane based adhesive, for example. Once the upper interfacing structure 56 is secured relative to the upper enclosure structure 46, the thermal barrier assembly 34 can substantially prevent thermal energy from moving from one compartment 36 to another at the sealed interface between the thermal barrier assembly 34 and the upper enclosure structure 46, such as during a battery thermal event, for example.

The lower interfacing structure 58 may be disposed on an opposite end of the thermal barrier structure 50 from the upper interfacing structure 56. The lower interfacing structure 58 may be received within a slot 64 formed in the lower enclosure structure 48. The lower interfacing structure 58 may therefore help locate the thermal barrier assembly 34 relative to the lower enclosure structure 48 during traction battery pack assembly.

A thermal interface material 66, which could be an adhesive or an insulation material, for example, may be utilized to secure the lower interfacing structure 58 to the lower enclosure structure 48. The thermal interface material 66 could have sealing properties for sealing the interface between the thermal barrier assembly 34 and the lower enclosure structure 48. The thermal interface material 66 (e.g., epoxy resin, silicone based materials, thermal greases, etc.) may additionally be disposed between the battery cells 32 of the cell stack 22 and the lower enclosure structure 48 and further between the heat spreader fins 55 and the lower enclosure structure 48 for facilitating heat transfer therebetween.

Once the upper interfacing structure 56 is joined to the upper enclosure structure 46 and the lower interfacing structure 58 is joined to the lower enclosure structure 48, the upper and lower enclosure structures 46, 48 are effectively structurally coupled to one another. The thermal barrier assemblies 34 can therefore be configured for increasing the structural stiffness of the traction battery pack 18. The thermal barrier assemblies 34 could additionally be structurally connected to the cross-member assembly 38 or to a busbar module with an adhesive and/or sealant.

One heat spreader fin 55 may be arranged on each side of the thermal barrier structure 50. In an embodiment, each heat spreader fin 55 is sandwiched between one of the insulation layers 52 and one of the foam layers 54 of the thermal barrier assembly (see FIG. 3). In another embodiment, heat spreader fins 55 may be sandwiched between the thermal barrier structure 50 and the insulation layers 52 and further between the insulation layers 52 and the foam layers 54 (see FIG. 4).

The heat spreader fins 55 may each include a body 68 and a leg 72 that extends transversely (e.g., about perpendicular) from the body 68. The body 68 may be sandwiched axially between one of the insulation layers 52 and one of the foam layers 54 (see FIG. 3) or axially between the thermal barrier structure 50 and one of the insulation layers 52 (see FIG. 4). In an embodiment, the body 68 and the leg 72 are arranged to establish an L-shape cross-section of the heat spreader fin 55. However, other shapes are contemplated within the scope of this disclosure.

The leg 72 of each heat spreader fin 55 may be arranged to extend between one of the insulation layers 52 of the thermal barrier assembly 34 and the lower enclosure structure 48. The TIM 66 may be applied between the leg 72 and the lower enclosure structure 48 for facilitating heat transfer therebetween. Arranging the heat spreader fins 55 in this manner enables thermal energy to be spread more evenly through the heat spreader fins 55 and then into the lower enclosure structure 48 while eliminating cold side battery cell hot spots. Cold side battery cell temperatures can therefore be kept below battery thermal event trigger temperatures.

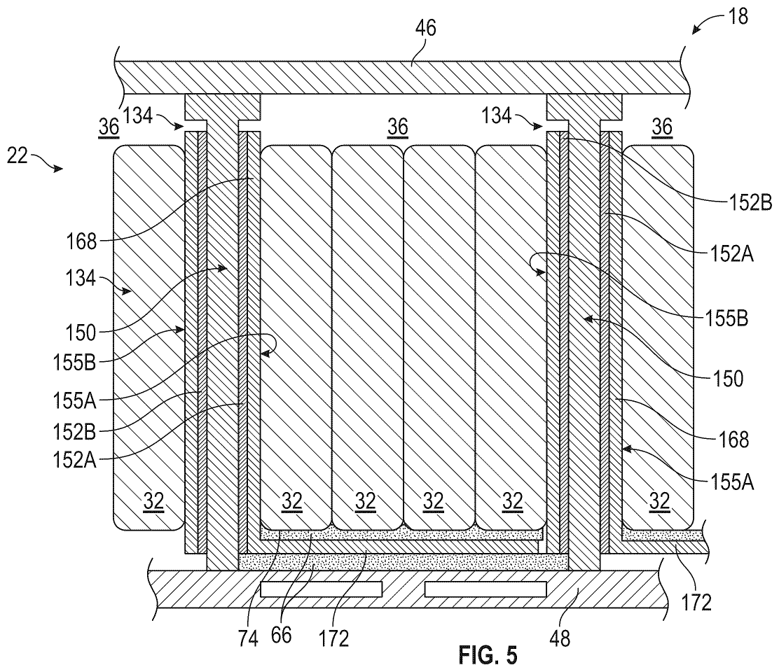

FIG. 5 illustrates another exemplary thermal barrier assembly 134 that could be utilized within one of the cell stacks 22 of the traction battery pack 18 for inhibiting the transfer of thermal energy, such as from one compartment 36 to another compartment 36 of the cell stack 22, for example. The thermal barrier assembly 134 may include a thermal barrier structure 150 that is flanked by insulation layers 152A, 152B and heat spreader fins 155A, 155B as part of a multi-layer sandwich structure of the thermal barrier assembly 34. For example, in this implementation, the thermal barrier structure 150 is sandwiched between the first insulation layer 152A and the second insulation layer 152B, a first heat spreader fin 155A is arranged to flank the first insulation layer 152A, and a second heat spreader fin 155B is arranged to flank the second insulation layer 152B.

The first heat spreader fin 155A may include a body 168 and a leg 172 that extends transversely from the body 168. The body 168 may be disposed axially between the first insulation layer 152A and a major side surface of one of the battery cells 32 of the cell stack 22. In an embodiment, the body 168 and the leg 172 are arranged to establish an L-shape cross-section of the first heat spreader fin 155A. However, other shapes are contemplated within the scope of this disclosure.

The leg 172 of the first heat spreader fin 155A may be arranged to extend between bottom surfaces 74 (e.g., minor side surfaces) of the battery cells 32 and the lower enclosure structure 48. The leg 172 may be long enough to extend beneath each battery cell 32 associated with one of the compartments 36 of the cell stack 22.

A TIM 66 may be applied between the leg 172 and the bottom surfaces 74 of the battery cells 32 and further between the leg 172 and the lower enclosure structure 48 for facilitating heat transfer between the battery cells 32 and the lower enclosure structure 48. Arranging the first heat spreader fin 155A of the thermal barrier assembly 134 in this manner enables thermal energy to be spread more evenly through the first heat spreader fin 155A and then into the lower enclosure structure 48 while eliminating cold side battery cell hot spots. Cold side battery cell temperatures can therefore be kept below battery thermal event trigger temperatures.

The second heat spreader fin 155B may be configured differently than the first heat spreader fin 155A. For example, the second heat spreader fin 155B may exclude the leg 172 and therefore does not include any portion that extends beneath battery cells 32 of the compartment 36. In an embodiment, the second heat spreader fin 155B of the thermal barrier assembly 134 is positioned in contact with a battery cell 32 from a different compartment 36 of the cell stack 22 than the compartment 36 that contains the battery cells 32 that interface with the leg 172 of the first heat spreader fin 155B of the thermal barrier assembly 134.

In an embodiment, the second heat spreader fin 155B is configured as a rectangular sheet-like structure. However, other configurations are contemplated within the scope of this disclosure.

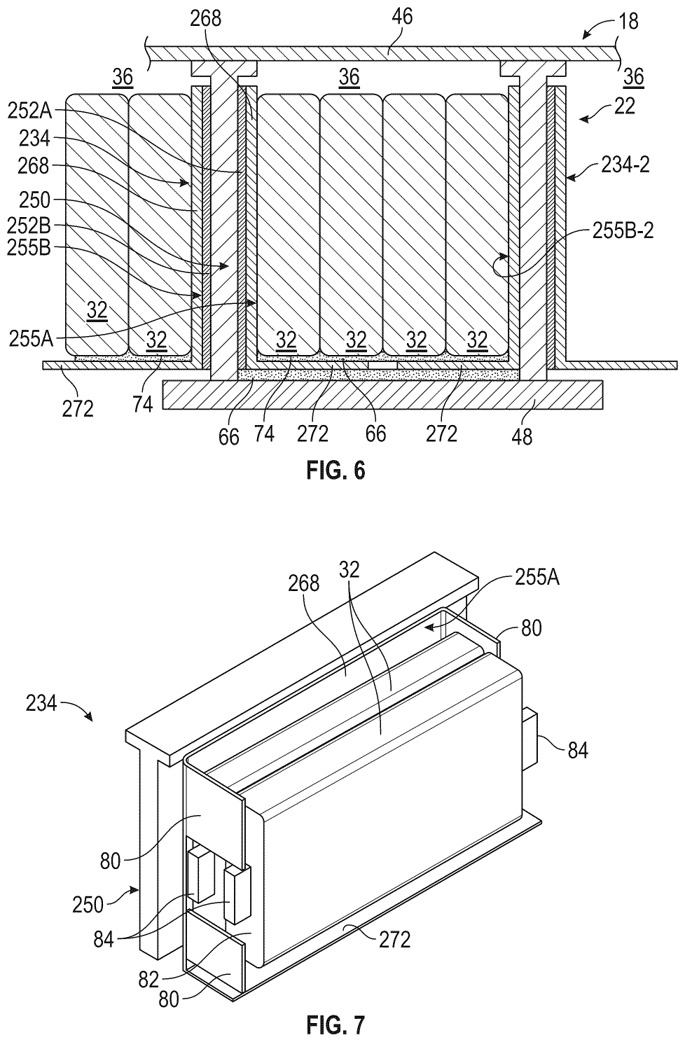

FIGS. 6 and 7 illustrates another exemplary thermal barrier assembly 234 that could be utilized within the cell stacks 22 of the traction battery pack 18 for inhibiting the transfer of thermal energy. The thermal barrier assembly 234 may include a thermal barrier structure 250 that is flanked by insulation layers 252A, 252B and heat spreader fins 255A, 255B as part of a multi-layer sandwich structure of the thermal barrier assembly 234. For example, in this exemplary implementation, the thermal barrier structure 250 is sandwiched between a first insulation layer 252A and a second insulation layer 252B, a first heat spreader fin 255A is arranged to flank the first insulation layer 252A, and a second heat spreader fin 255B is arranged to flank the second insulation layer 252B.

Each of the first and second heat spreader fins 255A, 255B may include a body 268 and a leg 272 that extends transversely from the body 268. The body 268 may be disposed axially between the first insulation layer 252A or the second insulation layer 252B and a major side surface of one of the battery cells 32 of the cell stack 22. In an embodiment, the body 268 and the leg 272 are arranged to establish an L-shape cross-section of each of the first and second heat spreader fins 255A, 255B. However, other shapes are contemplated within the scope of this disclosure.

The leg 272 of the first heat spreader fin 255A may be arranged to extend between bottom surfaces 74 of one or more battery cells 32 of one of the compartments 36 and the lower enclosure structure 48. The leg 272 of a second heat spreader fin 255B-2 of an additional thermal barrier assembly 234-2 of the cell stack 22 may be arranged to extend between bottom surface 74 of additional battery cells 32 within the compartment 36. In addition, the leg 272 of the second heat spreader fin 255B of the thermal barrier assembly 234 may be arranged to extend between bottom surfaces 74 of battery cells 32 located in a different compartment 36 from those that interface with the leg 272 of the first heat spreader fin 255A.

A TIM 66 may be applied between the legs 272 and the bottom surfaces 74 of the battery cells 32 and further between the legs 272 and the lower enclosure structure 48 for facilitating heat transfer between the battery cells 32 and the lower enclosure structure 48. Arranging the first and second heat spreader fins 255A, 255B in this manner enables thermal energy to be spread more evenly through the heat spreader fins 255A, 255B and then into the lower enclosure structure 48 while eliminating cold side battery cell hot spots. Cold side battery cell temperatures can therefore be kept below battery thermal event trigger temperatures.

As best shown in FIG. 7, the first heat spreader fin 255A and/or the second heat spreader fin 255B may additionally include one or more tabs 80 that project transversely away from the body 268. The tabs 80 may extend to a position adjacent to an end surface 82 (e.g., another minor side surface) of the battery cells 32. The tabs 80 may extend from different locations of the body 268 compared to the location the leg 272 extends from. The leg 272 and the tabs 80 may cooperate to at least partially wrap around a portion of the battery cells 32 of the cell stack 22 and can thus facilitate increased heat transfer between the battery cells 32 and the first and second heat spreader fins 255A, 255B.

Tab terminals 84 of the battery cells 32 may project outwardly of the end surface 82. The tab terminals 84 are uncovered by the tabs 80 and are thus unobstructed from properly interfacing with the cross-member assemblies 38 or other structures of the traction battery pack 18.

The thermal barrier assemblies of this disclosure provide for blocking gases and protecting surrounding structures while maintaining structure, sealing, and thermal resistance in a relatively thin profile compared to prior thermal barriers. The exemplary thermal barrier assemblies may include heat spreader fins designed to distribute thermal energy into surrounding heat sinks while eliminating cold side battery cell hot spots.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a thermal barrier assembly arranged to partition a battery cell stack into a first compartment and a second compartment; and
a first heat spreader fin of the thermal barrier assembly configured to establish a path for directing thermal energy from a battery cell of the battery cell stack into an enclosure structure of the traction battery pack,
wherein the first heat spreader fin extends between a first insulation layer of the thermal barrier assembly and the enclosure structure or extends between the battery cell and the enclosure structure.

2. The traction battery pack as recited in claim 1, wherein the enclosure structure is a heat exchanger plate of the traction battery pack.

3. The traction battery pack as recited in claim 1, wherein the first heat spreader fin includes an L-shaped cross-section.

4. The traction battery pack as recited in claim 1, wherein the first heat spreader fin includes a metallic structure.

5. The traction battery pack as recited in claim 1, wherein the first heat spreader fin is sandwiched between the first insulation layer and a first foam layer of the thermal barrier assembly.

6. The traction battery pack as recited in claim 1, wherein the first heat spreader fin is sandwiched between the first insulation layer and a thermal barrier structure of the thermal barrier assembly.

7. The traction battery pack as recited in claim 6, wherein the thermal barrier structure is a pultrusion.

8. The traction battery pack as recited in claim 6, wherein the thermal barrier structure includes an upper interfacing structure having an upper plateau configured to interface with a second enclosure structure of the traction battery pack.

9. The traction battery pack as recited in claim 8, wherein the second enclosure structure is part of an enclosure cover of an enclosure assembly of the traction battery pack.

10. The traction battery pack as recited in claim 1, comprising a thermal interface material disposed between the first heat spreader fin and the enclosure structure.

11. The traction battery pack as recited in claim 1, comprising a thermal interface material disposed between the battery cell and the first heat spreader fin and further between the first heat spreader fin and the enclosure structure.

12. The traction battery pack as recited in claim 1, wherein the first heat spreader fin includes a body and a leg that extends transversely from the body.

13. The traction battery pack as recited in claim 12, wherein the leg extends to a position that is between the first insulation layer and the enclosure structure or between the battery cell and the enclosure structure.

14. The traction battery pack as recited in claim 12, wherein the leg extends from a first location of the body, and further comprising a tab that extends from a second location of the body.

15. The traction battery pack as recited in claim 14, wherein the leg extends beneath a bottom surface of the battery cell, and the tab extends to a position adjacent to an end surface of the battery cell.

16. A traction battery pack, comprising:
an upper enclosure structure;
a lower enclosure structure; and
a cell stack arranged between the upper enclosure structure and the lower enclosure structure, wherein the cell stack includes a first grouping of battery cells, a second grouping of battery cells, and a thermal barrier assembly that separates the first grouping of battery cells from the second grouping of battery cells,
wherein the thermal barrier assembly includes a thermal barrier structure sandwiched between a first insulation layer and a second insulation layer, a first heat spreader fin that flanks the first insulation layer, and a second heat spreader fin that flanks the second insulation layer.

17. The traction battery pack as recited in claim 16, wherein the first heat spreader fin extends between the first insulation layer and the lower enclosure structure.

18. The traction battery pack as recited in claim 16, wherein the first heat spreader fin extends between the first grouping of battery cells and the lower enclosure structure.

19. The traction battery pack as recited in claim 18, wherein a second heat spreader fin of a second thermal barrier assembly extends between the first grouping of battery cells and the lower enclosure structure.

20. The traction battery pack as recited in claim 16, wherein the first heat spreader fin is flanked by a first foam layer, and the second heat spreader fin is flanked by a second foam layer.
